(19) United States
(12) Patent Application Publication
(10) Pub. No.: US 2014/0201951 A1
(43) Pub. Date: Jul. 24, 2014

(54) TABS AND BINDER CLIP TAB ASSEMBLIES COMPRISING SAME

(71) Applicants: Lori A. Starken, Woodbury, MN (US); David C. Windorski, Woodbury, MN (US)

(72) Inventors: Lori A. Starken, Woodbury, MN (US); David C. Windorski, Woodbury, MN (US)

(73) Assignee: 3M Innovative Properties Company, St, Paul, MN (US)

(21) Appl. No.: 14/342,420

(22) PCT Filed: Sep. 4, 2012
(86) PCT No.: PCT/US2012/053650

§ 371 Date: Mar. 3, 2014

Related U.S. Application Data
(60) Provisional application No. 61/531,894, filed on Sep. 7, 2011.

(51) Int. Cl. B42F 1/02

(52) U.S. Cl. CPC B42F 1/02
USPC 24/67.5

(57) ABSTRACT

A tab and binder clip tab assemblies comprising same. The tab can include a front side; a back side opposite the front side; a side edge; and an aperture dimensioned to receive at least a portion of the binding portion of the binder clip, the aperture extending through the side edge of the tab to form at least one movable member in the tab. At least a portion of the tab can be positioned to extend beyond a top end of the binding portion of the binder clip when the tab and the binder clip are coupled together. The binding portion of the binder clip can include a first leg and a second leg that are biased toward one another and configured to retain at least a portion of the object between the first leg and the second leg.

### FIELD

The present disclosure generally relates to tabs for flagging, identifying, categorizing and/or organizing articles (e.g., documents), and binder clip tab assemblies comprising such tabs for coupling to an object or for binding multiple articles or objects together while providing a tab or flag for identification, organization and/or note-taking.

### BACKGROUND

In working with large stacks of documents, it can be desirable to categorize the documents or to flag a document that is of particular interest. Tabs or flags can be useful to categorize documents by signaling when one category ends and another begins or to highlight a page of particular importance. In addition to tabbing or flagging a page, it can be desirable to make notes on that page. However, depending on the importance of maintaining the original document, marking directly on the flagged page may not be desirable.

Some existing tabs or flags may allow for flagging and note-taking, but may not allow for binding the object, or plurality of objects, separately from other objects (e.g., documents) to adequately categorize such objects. As such, a tab or flag may need to be employed in conjunction with other articles or devices, such as paperclips, binder clips, elastic bands, or other suitable fasteners.

### SUMMARY

Some existing paperclips or binder clips, or assemblies comprising paperclips or binder clips employ paperclips or binder clips inserted through an opening in a sheet, such that the sheet can be coupled to an object with the clip, and such that the sheet can function as a tab or flag. However, such assemblies generally do not include an easily replaceable tab, such that the tab of such assemblies can be replaced again and again, as desired, without damage or destruction to either the binder clip or the tab. In addition, such assemblies generally do not include a stack of sheets of papers on the tab, such that the writable surface of the tab or flag can be reused (e.g., until the stack of sheets is depleted).

The tabs and binder clip tabs of the present disclosure afford easy-to-use and attractive filing and organizing of various articles or objects, such as paper, documents, envelopes, files, or the like. The binder clip tabs can allow for facile re-arrangement or re-organization, and can provide secure binding of various articles together, while providing a writable surface and a tab or flag portion that extends beyond an edge of the group of articles for enhanced filing, organization, and retrieval of desired articles. In some embodiments, the binder clip tabs of the present disclosure can be employed to bind various articles together, but can also be used to facilitate categorizing and/or retrieving the bound articles.

Some embodiments of the present disclosure provide a binder clip tab for coupling to an object having an edge. The binder clip tab can include a binder clip having a binding portion comprising a first leg and a second leg that are biased toward one another and configured to retain at least a portion of the object between the first leg and the second leg. The binder clip tab can further include a tab having a front side, a back side, and a side edge, and being configured to be removably coupled to the binding portion of the binder clip, the tab including an aperture dimensioned to receive at least a portion of the binding portion of the binder clip therethrough, the aperture extending through the side edge of the tab to form at least one movable member in the tab. At least a portion of the tab can be positioned to extend beyond a top end of the binding portion of the binder clip, such that when the binder clip tab is coupled to the object, the tab extends beyond the edge of the object.

Some embodiments of the present disclosure provide a tab for removably coupling to a binder clip having a binding portion. The tab can include a front side; a back side opposite the front side; a side edge; and an aperture dimensioned to receive at least a portion of the binding portion of the binder clip, the aperture extending through the side edge of the tab to form at least one movable member in the tab. At least a portion of the tab can be positioned to extend beyond a top end of the binding portion of the binder clip when the tab and the binder clip are coupled together.

Other features and aspects of the present disclosure will become apparent by consideration of the detailed description and accompanying drawings.

### BRIEF DESCRIPTION OF THE DRAWINGS

FIG. 1 is perspective view of a tab according to one embodiment of the present disclosure, showing the tab optionally as one of a plurality of tabs in a sheet assembly.

FIG. 2 is perspective view of a binder clip tab according to one embodiment of the present disclosure, showing the binder clip tab optionally as one of a plurality of binder clip tabs in a sheet assembly; the binder clip tab comprising a binder clip and a tab coupled to the binder clip.

FIG. 3 is a side view of the binder clip tab of FIG. 2 coupled to an object.

FIG. 4 is a front view of the binder clip tab of FIGS. 2-3 coupled to the object.'

FIG. 5 is a front view of a tab according to another embodiment of the present disclosure.

FIG. 6 is a front view of a tab according to another embodiment of the present disclosure.

### DETAILED DESCRIPTION

Before any embodiments of the present disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “supported,” and “coupled” and variations thereof are used broadly and encompass both direct and indirect mountings, connections, supports, and couplings. Further, “connected” and “coupled” are not restricted to physical or mechanical connections or couplings. It is to be understood that other embodiments may be utilized, and structural or logical changes may be made without departing from the scope of the present disclosure. Furthermore, terms such as “front,” “rear,” “top,” “bottom,” “first,” “second,” and the like are only used to describe elements as they relate to one another, but are in no way meant to recite specific orientations of the apparatus, to indicate or imply necessary or required orientations of the apparatus, or to specify how the invention described herein will be used, mounted, displayed, or positioned in use.

The present disclosure generally relates tabs, which, in some embodiments, can include a front side, a back side, and an aperture formed therethrough that extends through a side edge of the tab to form at least one movable member that can move, flex and/or pivot (e.g., about a living hinge) to facilitate coupling the tab to a binder clip to form a binder clip tab or binder clip tab assembly of the present disclosure.

The tabs and binder clip tabs of the present disclosure can be used in a variety of applications, including but not limited to, tabbing one or more articles (e.g., for facile retrieval or identification), binding various articles together, filing, organizing, or combinations thereof. For example, in some embodiments, the binder clip tabs can be used to bind, file and/or organize sheets of paper, envelopes, bills, to-do lists, calendars, pages of a book (including magazines, catalogs, reference manuals, etc.), projects, recipe cards, newspapers or clippings thereof, other suitable articles or objects, or combinations thereof. In some embodiments, the tabs and/or binder clip tabs can be color-coded, for example, such that the tabs and/or binder clip tabs can be employed at one time, each tab and/or binder clip tab designated for a different use, purpose, project, or the like.

U.S. Patent Application No. 61/425,838 (Attorney Docket No. 67076US002) generally describes binding systems that employ folded sections and recessed adhesive zones, and is incorporated herein by reference in its entirety. U.S. Patent Application Nos. 61/531,833, 61/531,840, and 61/531,875, filed Sep. 7, 2011, describe paperclip tabs, each of which is incorporated herein by reference in its entirety. U.S. Patent Application No. 61/531,854, filed Sep. 7, 2011, describes recessed adhesive binding tabs, and is incorporated herein by reference in its entirety. U.S. Patent Application Nos. 61/531,887 and 61/531,907, filed Sep. 7, 2011, describe binder clip tabs, each of which is incorporated herein by reference in its entirety.

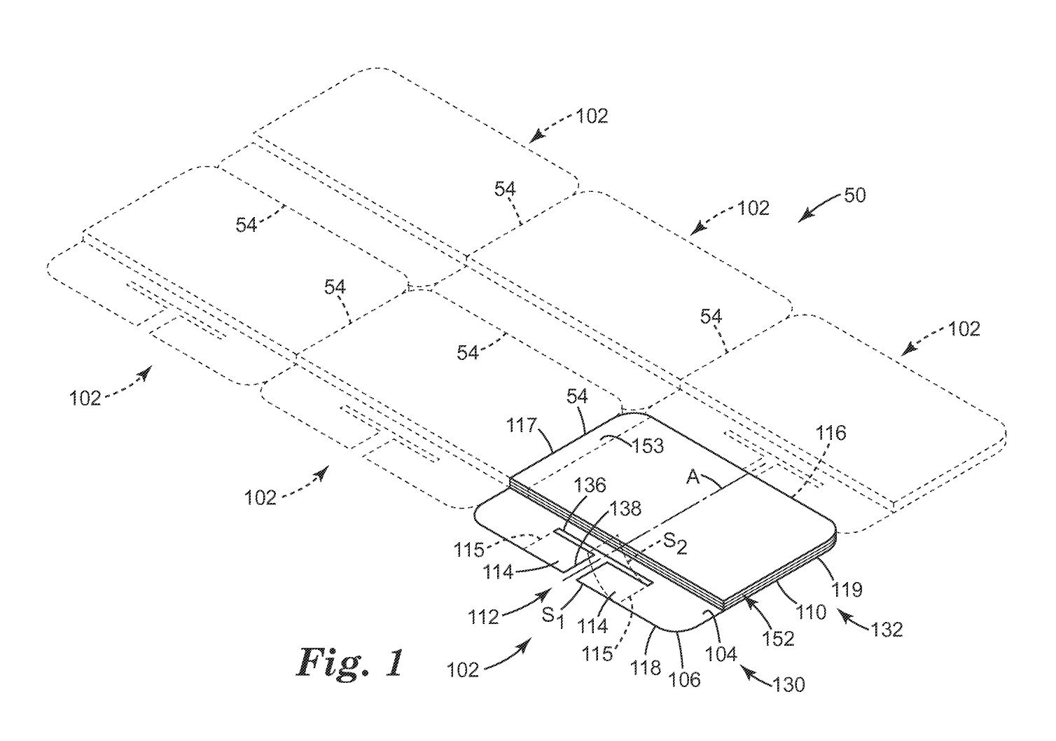

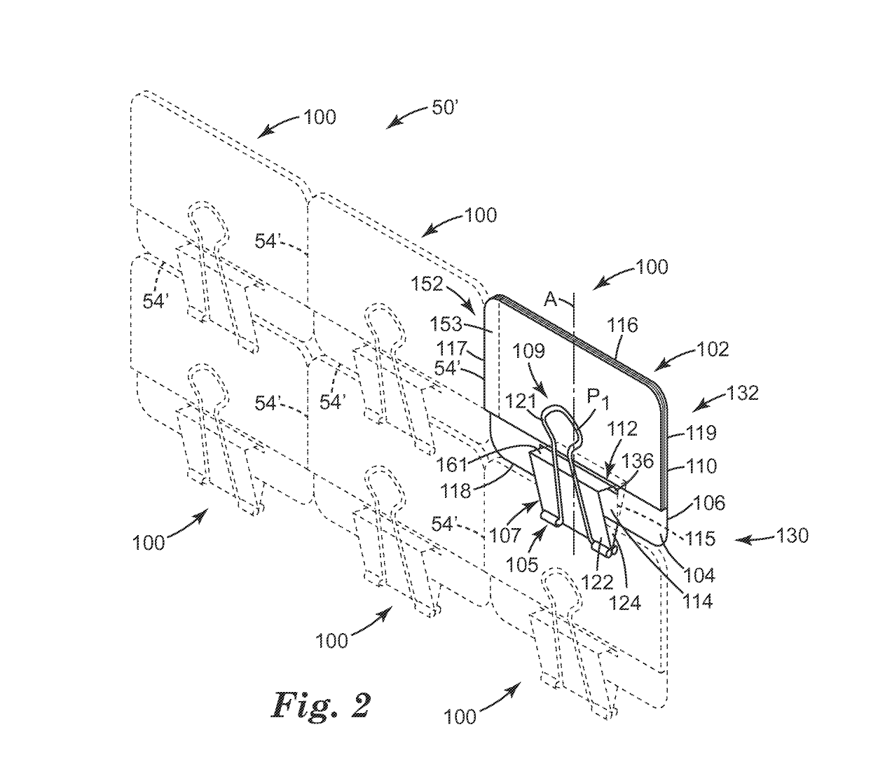

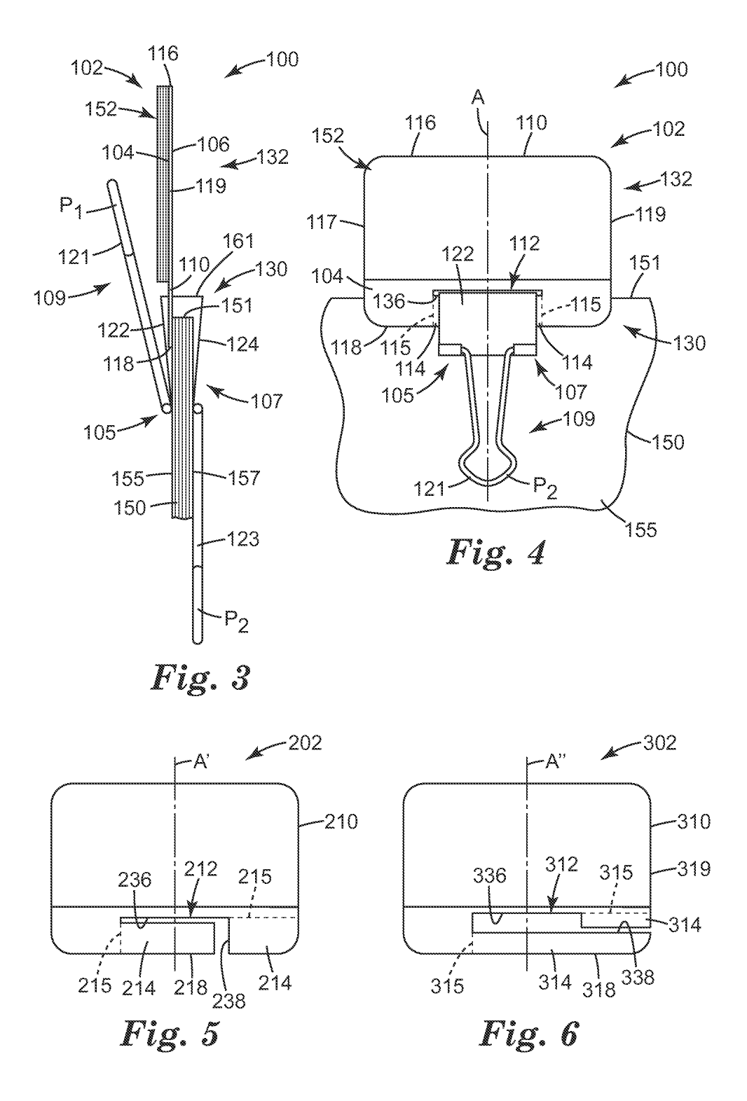

FIG. 1 illustrates a tab (or “substrate” or “sheet”) 102 according to one embodiment of the present disclosure. FIGS. 2-4 illustrate a binder clip tab (or “assembly” or “binder clip tab assembly”) 100 according to one embodiment of the present disclosure, the binder clip tab 100 comprising the tab 102 coupled to a binder clip 105. FIGS. 3-4 illustrate the binder clip tab 100 coupled to an object, article or plurality of objects or articles (e.g., a stack of documents) 150 having an edge 151, a front 155, and a back 157.

As shown in FIG. 1, in some embodiments, the tab 102 can include a front side 104, a back side 106 opposite the front side, a side edge or sidewall 110, and an aperture 112 formed through the tab 102, such that the aperture 112 extends through the front side 104 and the back side 106 and through the side edge 110. That is, the aperture 112 can connect and open to the side edge 110 of the tab 102, such that the side edge 110 includes a break or opening. By connecting or extending the aperture 112 through a side edge 110 of the tab 102, one or more movable members 114 can be formed. Such movable members 114 can be used to facilitate removably and/or replaceably coupling the tab 102 to a binder clip. As further shown in FIGS. 2-4 and described below, the aperture 112 can also be dimensioned to receive at least a portion of the binder clip 105. The tab 102 can be shaped and configured, such that when the tab 102 is coupled to a binder clip 105, and further coupled to the object 150, at least a portion of the tab 102 can extend beyond the edge 151 of the object 150 for easy retrieval, flagging, identification, categorization and/or organization. In some embodiments, the aperture 112 can be referred to as an “aperture,” an “opening,” a “slit,” a “passage,” a “notch,” or a combination thereof.

The tab 102 can be formed of a variety of materials, including, but not limited to, one or more of paper, cardstock, cardboard, plastic film, other suitable materials, or a combination or laminate thereof. In some embodiments, the front side 104 of the tab 102 can be colored (e.g., stained, coated, dyed, etc.) for an attractive appearance, for example, that affords high contrast between the binder clip tab 100 and articles to be bound, filed and/or organized by the binder clip tab 100. Furthermore, in some embodiments, at least the front side 104 of the tab 102 can be configured to receive (i.e., be receptive to) ink, dyes, print, toner, marks, or the like, such that at least the front side 104 can be writable, printable, and/or stainable and can serve as a writing surface, a printing surface, or the like.

In some embodiments, no matter what overall shape or configuration the tab 102 has, the tab 102 can include a first (e.g., top) end or edge 116 that generally can protrude out from an edge of the object 150 when the tab 102 is coupled to the object 150 (e.g., by the binder clip 105), and a second (e.g., bottom) end or edge 118. In addition, in some embodiments, as shown in FIG. 1, the tab 102 can include one or more sides, such as a left side 117 and a right side 119, for example, when the tab 102 is generally square or rectangular in shape. However, it should be understood that the tab 102 can have a variety of shapes and configurations, including, but not limited to, the shape of a triangle, a circle, an ellipse, an oblong shape, a polygon, a trapezoid, a parallelogram, a square, a rectangle, other suitable shapes, or combinations thereof. As such, the side edge 110 of the tab 102 can be formed or defined by one or more sides, ends or edges of the tab 102, and the aperture 112 can extend through the side edge 110 of the tab 102, adjacent any of such sides, ends or edges. In the embodiment illustrated in FIG. 1, the aperture 112 is shown as extending through, or connecting to, the second end 118.

The binder clip 105 can include a first leg 122 and a second leg 124 that are biased toward one another to retain the object 150 (see FIGS. 3-4) between the first leg 122 and the second leg 124. As shown, in some embodiments, the tab 102 can include a portion that is positioned to extend at least partially between the first leg 122 and the second leg 124 of the binder clip 105. That is, in some embodiments, the tab 102 and/or the binder clip tab 100 can include a body portion (or body) 130 and a tab portion (or tab, or flag, or flag portion) 132.

The body portion 130 can generally be described as the portion of the tab 102 and/or the binder clip tab 100 that fits adjacent the object 150 and does not extend beyond the edge 151 of the object 150, whereas the tab portion 132 is generally defined as the portion of the tab 102 and/or the binder clip tab 100 that extends beyond the edge 151 of the object 150 when the binder clip 105 and the binder clip tab 100 are coupled to the object 150. In some embodiments, the “tab portion” 132 can be referred to as the “flag portion,” the “extension portion,” the “identification portion,” or the “overhanging portion.”

In some embodiments, the body portion 130 (or lower portion) of the tab 102 can be positioned between the first leg 122 and the second leg 124 of the binder clip 105 when the tab 102 and the binder clip 105 are coupled together, and the body portion 130 (e.g., the portion including the second end 118) can be positioned in front of the front 155 of the object 150 (e.g., as shown in FIGS. 3 and 4), in back of the back 157 of the object 150, or above the top end 161 of the binder clip 105.

In some embodiments, the body portion 130 of the tab 102 can move or shift slightly while the tab 102 is coupled to the binder clip 105, such that a user can decide where to locate the body portion 130 relative to the object 150 when the binder clip tab 100 is coupled to the object 150. In some embodiments, as shown in FIG. 3, at least a portion of the tab 102 (e.g., the body portion 130) can be held or pinned in place between the object 150 (e.g., the front 155 or the back 157 of the object 150) and a portion of the binding portion 107 of the binder clip 105 (e.g., the first leg 122 or the second leg 124) when the binder clip tab 100 is coupled to the object 150. In such embodiments, the tab 102 can reliably remain in place during use.

In some embodiments of the binder clip tab 100, the body portion 130 can include at least a portion of the binder clip 105 (e.g., a binding portion 107, as described below) and a portion of the tab 102 (e.g., a portion adjacent the second end 118 that extends between the first leg 122 and the second leg 124). Furthermore, in some embodiments of the binder clip tab 100, the tab portion 132 can include at least a portion of the tab 102 (e.g., the portion of the tab 102 that extends beyond, e.g., above, the aperture 112).

While the first leg 122 of the binder clip 105 is described and illustrated as forming a front of the binder clip 105 and the second leg 124 of the binder clip 105 is described and illustrated as forming a back of the binder clip 105, it should be understood that the designation of the “first leg” and the “second leg” is by way of example only for illustration purposes, and that in some embodiments, the first leg 122 of the binder clip 105 can form the back of the binder clip 105, and the second leg 124 of the binder clip 105 can form the front of the binder clip 105.

The first leg 122 and the second leg 124 can be movable against the bias to release the object when desired. In some embodiments, as shown, the binder clip 105 can further include a first leverage arm 121 and a second leverage arm 123, wherein each leverage arm 121, 123 includes a first position P₁ in which the leverage arm 121, 123 is positioned to be pressed (or squeezed, e.g., simultaneously) toward the other leverage arm 123, 121, respectively, to move the first leg 122 and the second leg 124 apart against their bias, and a second position P₂ in which the leverage arm 121, 123 does not provide leverage against the bias between the first leg 122 and the second leg 124. Rather, in the second position P₂, the leverage arm 121, 123 can provide added security of the binder clip 105 and the binder clip tab 100 to the object 150, because the leverage arm 121, 123 acts as an “extension” of the binder clip 105 and extends adjacent a front 155 and a back 157 of the object 150 (see FIGS. 3 and 4) and/or because in the second position P₂, the leverage arm 121, 123 is not in a position in which it can act to separate the first leg 122 and the second leg 124. In some embodiments, the first and second leverage arms 121, 123 can be biased against the object 150 (e.g., the front 155 and/or the back 157) when the leverage arm 121, 123 is in the second position P₂.

By way of example only, in FIG. 3, the first leverage arm 121 is shown in the first position P₁, and the second leverage arm 123 is shown in the second position P₂. FIG. 4 shows the binder clip 105 of the binder clip tab 100 coupled to the edge 151 of the object 150, after the first leverage 121, 123 has been moved into the second position P₂ for added security.

In some embodiments, the portion of the binder clip 105 comprising the first leg 122 and the second leg 124 (and optionally, a first (or top) end 161 of the binder clip 105) can be referred to as the “binding portion” or the “clipping portion” 107 of the binder clip 105. In some embodiments, the portion of the binder clip 105 comprising the leverage arms 121 and 123 can be referred to as the “leverage portion” 109 of the binder clip 105.

A variety of styles of binder clips (or other suitable fasteners, paperclips, clips, or the like) can be employed that are suitable for retaining an object such as a sheet of paper, or a plurality of sheets of paper. The illustrated binder clip 105 is shown by way of example only, however, it should be understood that binder clips having a variety of shapes, sizes and configurations can be employed without departing from the spirit and scope of the present disclosure. In addition, the binder clip 105 can be formed of a variety of materials, including metal (e.g., wire), plastic, coated metal, coated plastic, other suitably rigid and strong materials, or combinations thereof.

As further shown in FIG. 1, in some embodiments, the aperture 112 can include more than one leg or portion, such that the aperture 112 can turn or bend to connect to the side edge 110 of the tab 102, or such that the aperture 112 can widen or narrow, as needed, to form an aperture shape and one or more movable members 114 that can accommodate the binder clip 105.

In the embodiment shown in FIGS. 1-4, the aperture 112 includes a first portion 136 dimensioned to retain at least a portion (e.g., at least a portion of the binding portion 107, such as the top end 161) of the binder clip 105. As shown, the aperture 112 can include a second portion 138 configured (e.g., positioned) to connect the first portion 136 to the side edge 110 of the tab 102, such that the second portion 138 of the aperture 112 extends through the side edge 110. Such a configuration of the aperture 112 comprising a first portion 136 and a second portion 138 is shown by way of example only; however, it should be understood that other configurations are possible, including configurations that include more than two portions.

In some embodiments, as shown in FIGS. 1-4, the aperture 112 can be symmetrical about a longitudinal axis A (or a vertical center or a center longitudinal axis); however, this need not be the case, as shown in FIGS. 5 and 6 and described below.

In addition, in some embodiments, as shown in FIG. 1, the second portion 138 of the aperture 112 can be centered with respect to the first portion 136; however, this need not be the case. In embodiments in which the second portion 138 of the aperture 112 is centered with respect to the first portion 136, however, the second portion 138 can be hidden from view when the binder clip 105 is coupled to the tab 102, which can afford a clean and professional appearance.

Furthermore, in some embodiments, as shown in FIG. 1, the first portion 136 and the second portion 138 of the aperture 112 are oriented substantially perpendicularly with respect to one another; however, this need not be the case. By way of example only, because the second portion 138 is also centered with respect to the first portion 136 of the aperture 112, in some embodiments, as shown, the aperture 112 can have a T-shape. As shown in FIG. 1 by way of example, the perpendicular orientation between the first portion 136 and the second portion 138 of the aperture 112 can occur, for example, when the first portion 136 is oriented substantially parallel with respect to an end (e.g., the second end 118) of the tab 102, and the second portion 138 is oriented substantially perpendicularly with respect to the same end (e.g., the second end 118) of the tab 102.

As described above, the aperture 112 can extend through the side edge 110 of the tab 102 so that at least one movable member 114 is formed that can facilitate coupling and decoupling the tab 102 and the binder clip 105, as well as positioning the tab 102 on the binder clip 105, removing the tab 102 from the binder clip 105, and replacing the tab 102, for example, with a separate tab 102. In some embodiments, the first tab 102 can be replaced by another tab 102 that is the same as the first tab 102, or the first tab 102 can be replaced by a different tab.

As shown in FIG. 1, in some embodiments, the tab 102 can include two movable members 114 at least partially defined by the aperture 112, and in some embodiments, the two movable members 114 can be symmetrical about the longitudinal axis A. In some embodiments, as shown in FIG. 1, the one or more movable members 114 can each be movable (e.g., pivotally movable or pivotable) relative to the remainder of, or another portion of, the tab 102 about a living hinge 115. In such embodiments, one or both of the movable members 114 can be moved about their respective living hinges 115 to couple the tab 102 and the binder clip 105 together.

As further shown in FIG. 1, each movable member 114 can be movable between a first position S₁ in which it lies substantially in the plane of the tab 102 (i.e., co-planar with the tab 102), and a second position S₂ in which the movable member 114 has been moved (e.g., about the living hinge 115) out of the plane of the tab 102 (i.e., to a position in which the movable member 114 is no longer co-planar with the tab 102). While the second position S₂ is shown in FIG. 1 as being above the plane of the tab 102, it should be understood that the second position S₂ can be either above or below the plane of the tab 102. In addition, the second position S₂ is shown by way of example only, but it should be understood that any position that is noticeably (e.g., tactilely or visually) out of the plane of the tab 102 can be referred to as the second position S₂.

In addition, in some embodiments, as shown in FIG. 1, at least partly because the movable members 114 are located symmetrically about the longitudinal axis A, the living hinges 115 can be oriented substantially parallel with one another. However, this need not be the case. Rather, in some embodiments, the living hinges 115 can be oriented substantially perpendicularly with respect to one (e.g., as shown in FIGS. 5 and 6 and described below). Still, in some embodiments, the living hinges 115 can be oriented an angle with respect to one another that is not parallel or perpendicular.

In the embodiment illustrated in FIGS. 1-4, at least one movable member 114 can be moved or flexed about its living hinge 115 enough to accommodate the binder clip 105 and to begin to slide the binding portion 107 of the binder clip 105 over the opposite movable member 114 and into the first portion 136 of the aperture 112. The movable members 114 can then be positioned between the first and second legs 122 and 124 of the binder clip 105, as shown in FIG. 2, for example, to at least partially hide the movable members 114 and/or the second portion 138 of the aperture 112 from view during normal operation of the binder clip tab 100. The movable members 114 and/or the aperture 112 can be sized and configured, such that the binder clip 105 is relatively secure on the tab 102 and does not fall out of the aperture 112 during normal use, or until desired.

As mentioned above, in some embodiments, the tab 102 (e.g., at least the front side 104) can be receptive to inks, dyes, or the like. Additionally or alternatively, in some embodiments, as shown in FIG. 1, the front side 104 of the tab 102 (e.g., in the tab portion 132) can include a multi-layer stack or tablet 152 of sheets, which can be receptive to inks, dyes, print, toner, marks, or the like, such that the sheets are writable, printable, and/or stainable and can serve as a writing surface, a printing surface, or the like. In some embodiments, the stack of sheets can be coupled together using an adhesive or glue that functions as a binding edge, or each of the sheets can be adhesive-backed (e.g., adhesive-backed film or paper), such that each sheet can be adhered to an underlying sheet (or the front side 104 of the tab 102) with an adhesive (e.g., a pressure-sensitive adhesive, such as repositionable adhesives described in greater detail below) on its rear surface. That is, in some embodiments, the stack 152 can include a stack of POST-IT® notes, POST-IT® Flags and/or POST-IT® Tabs, available from 3M Company, (St. Paul, Minn.). In such embodiments, the tab 102 or the binder clip tab 100 can be reused until the stack 152 is depleted, or in embodiments in which the front side 104 is also writable, printable and/or stainable, the tab 102 can be written or printed upon when the stack 152 is depleted. Alternatively, in some embodiments, the stack 152 can be replaced by a new stack 152 on the same tab 102.

The stack 152 is shown by way of example only as being coupled to the front side 104 of the tab 102, and particularly, to the front side 104 in the tab portion 132 of the tab 102; however, it should be understood that in some embodiments, the stack 152 can instead be coupled to the back side 106 of the tab 102, and particularly, can be coupled to whichever face or surface of the tab 102 that would face a user in use. In some embodiments, the tab 102 can include a stack 152 on its front side 104 and on its back side 106. In addition, it should be understood that in some embodiments, the stack 152 can instead be coupled to the body portion 130 (e.g., in embodiments in which the tab 102 is even wider than that of the tab 102 shown in FIGS. 1-4), or to a combination of the body portion 130 and the tab portion 132.

In some embodiments in which the stack 152 does not entirely obscure a front side 104 of the tab 102, at least the portion of the exposed front side 104 of the tab 102 can be writable, printable, and/or stainable. Alternatively, or additionally, the tab 102 can include a plurality of stacks 152.

In addition, the stack 152 is shown as comprising generally rectangular or square-shaped sheets; however, it should be understood that any size or shape of sheets can be used in the stack 152. In addition, in the embodiment shown in FIGS. 1-4, the shape and size of the stack 152 is at least partially determined by the shape and size of the tab 102 (or of the tab portion 132 of the tab 102 or the binder clip tab 100). As a result, in embodiments employing other shapes of the tab 102, other shapes of the stack 152 can also be employed. Alternatively, the shape and size of the stack 152 need not be dictated by the size and shape of the tab 102, but rather can have a shape and size that is independent of the shape and size of the tab 102. In addition, any commercially-available type of POST-IT® notes, POST-IT® Flags and/or POST-IT® Tabs can be employed, including those of different shapes, colors, types of writing surfaces, and types of adhesive.

Furthermore, while one stack 152 is shown for illustration purposes, it should be understood that the tab 102 and the binder clip tab 100 of the present disclosure can include as few as zero stacks 152 and as many as desired.

In some embodiments, the tab 102 can be sized to form a suitable writing surface, either in the body portion 130, the tab portion 132, or both. In some embodiments, at least the front side 104 of the tab 102 can include lines for making notes. In addition, the tab 102 can have any size, shape or color, and while the overall shape (and width) of the body portion 130 and the tab portion 132 are shown as being essentially the same in the illustrated embodiments, in some embodiments, the body portion 130 can have a different shape or size than the tab portion 132. The tab portion 132 may also be of another color than the rest of the paperclip tab 100. Also, in some embodiments, one or both of the body portion 130 and the tab portion 132 can be preprinted with indicia, or have lines preprinted thereon to facilitate making notes.

Furthermore, in the embodiment illustrated in FIGS. 1-4, the tab 102 is shown as being wider and taller than the binder clip 105. However, this need not be the case. Rather, the tab 102 can be shaped and sized to form a body portion 130 and tab portion 132 of the binder clip tab 100 of any desired shape and size. In some embodiments, the tab 102 (e.g., the body portion 130) can be much wider than the binder clip 105 to provide a large writing surface on the tab 102, to accommodate a large stack 152, or the like.

In addition, as shown in FIGS. 1 and 2, in some embodiments, each sheet in the stack 152 can include a non-adhesive end or tab 153 to facilitate gripping and removing one sheet from the stack.

The adhesive employed in the stack 152 (e.g., when the stack 152 employs adhesive-backed sheets of film or paper) can be a pressure-sensitive adhesive. In some embodiments, the adhesive can provide good adhesion to a surface, while also being removable under moderate force without leaving a residue (e.g., removable and/or repositionable pressure-sensitive adhesives). However, in some embodiments, the adhesive can be an adhesive that binds more permanently, or adheres well, to itself.

Examples of suitable materials for the adhesive include one or more adhesives based on (meth)acrylates, urethanes, silicones, epoxies, rubber based adhesives (including natural rubber, polyisoprene, polyisobutylene, and butyl rubber, block copolymers, and thermoplastic rubbers), and combinations thereof.

Examples of suitable (meth)acrylates include polymers of alkyl acrylate monomers such as methyl methacrylate, ethyl methacrylate, n-butyl methacrylate, methyl acrylate, ethyl acrylate, n-butyl acrylate, iso-octyl acrylate, iso-nonyl acrylate, 2-ethyl-hexyl acrylate, decyl acrylate, dodecyl acrylate, n-butyl acrylate, hexyl acrylate, and combinations thereof. Examples of commercially available block copolymers include those available under the trade designation “KRATON G-1657” from Kraton Polymers, Westhollow, Tex.

As described above, in some embodiments, the adhesive can include a removable and/or repositionable pressure-sensitive adhesive. An adhesive is considered to be “removable,” if after final application to an intended substrate, the sheet or substrate can be removed at the end of the intended life of the article at a rate in excess of 7.62 meters/hour (25 feet/hour) by hand with the optional use of heat without damage to either the surface to which it is coupled (e.g., other sheets in the stack 152, portions of the tab 102, etc.). In some embodiments, the removable pressure-sensitive adhesive has a 180 degree peel strength (from a sheet of 400-gauge Mylar D PET film, available from the E. I. du Pont de Nemours and Company, Wilmington, Del.) of less than 8 N/cm, and more particularly, less than 6 N/cm.

The term “repositionable” generally refers to the ability to be, at least initially, repeatedly adhered to and removed from a surface without substantial loss of adhesion capability. In some embodiments, the repositionable pressure-sensitive adhesive has a 180 degree peel strength, at least initially, of less than about 2 N/cm, in some embodiments, less than about 1 N/cm, and in some embodiments, less than about 0.1 N/cm, when peeled from a sheet of 400-gauge Mylar D PET film, available from the E. I. du Pont de Nemours and Company, Wilmington, Del.

Examples of suitable removable and repositionable pressure-sensitive adhesives include those described in Hobbs et al., U.S. Publication No. 2005/0249791 and Cooprider et al., U.S. Pat. No. 5,571,617, both of which are incorporated herein by reference; and adhesives based on solid inherently tacky, elastomeric microspheres, such as those disclosed in Silver, U.S. Pat. No. 3,691,140, Merrill et al., U.S. Pat. No. 3,857,731, and Baker et al., U.S. Pat. No. 4,166,152; all of which are incorporated herein by reference. Other removable and repositionable pressure-sensitive adhesives that can be employed in the present disclosure include those employing the composite pressure-sensitive adhesive microspheres disclosed in Kesti et al., U.S. Pat. No. 5,824,748, which is incorporated herein by reference.

However, in some embodiments, a repositionable adhesive can be repositionable when adhered to a variety of surfaces (e.g., mounting surfaces), but not necessarily when it is adhered to itself (e.g., in the back-to-back configurations shown in the figures). That is, in some embodiments, the adhesive can have a greater affinity for itself than for other surfaces (e.g., the front side 104 of the tab 102 or another sheet in the stack 152, etc.).

In some embodiments, the adhesive can be substantially smooth. In some embodiments, the adhesive can be textured or include a topography. A topography can be beneficial for bleeding air out from beneath sheet or substrate as it is applied to a surface, thereby reducing the amount of trapped air pockets beneath the sheet. Examples of suitable topographies are discussed in Sher et al., U.S. Pat. No. 6,911,243, which is incorporated herein by reference.

In some embodiments, the thickness of the adhesive can be at least about 10 micrometers, in some embodiments, at least about 20 micrometers, and in some embodiments, at least about 50 micrometers. In some embodiments, the thickness of the adhesive can be no greater than about 300 micrometers, in some embodiments, no greater than about 200 micrometers, and in some embodiments, no greater than about 100 micrometers.

In some embodiments, the adhesive and/or the front surface an adjacent sheet in the stack 152 (or the front side 104 of the tab 102) can be configured such that the adhesive does not adhere (or does not adhere well). That is, in some embodiments, the adhesive can be configured to have a greater affinity for itself (e.g., if two sheets in the stack 152 were coupled back-to-back) than for the front side 104 of the tab 102 or the front surface of an adjacent sheet in the stack 152. As such, the adhesive can be configured so as not to unnecessarily wear out or lose its tackiness when not in use (e.g., when stored in the stack 152 versus in use).

The phrase “adheres well” can generally refer to the adhesive having a 90 degree peel strength, at least initially, of at least about 500 g, in some embodiments, at least about 800 g, and in some embodiments, at least about 1000 g (1 kg), when a 1-inch-(2.54 cm)-wide strip of the sheet having the adhesive on its rear surface is peeled from another substrate having the adhesive thereon.

The phrase “does not adhere well” can generally refer to the adhesive having a 90 degree peel strength, at least initially, of less than about 50 g, in some embodiments, less than about 30 g, and in some embodiments, less than about 20 g, when a 1-inch-(2.54 cm)-wide strip of the sheet having the adhesive on its rear surface is peeled from the front side 104 of the tab 102, the front surface or side of an adjacent sheet in the stack 152, or the like.

For example, in some embodiments, an adhesive comprising composite pressure-sensitive adhesive microspheres can be employed, such as the microspheres and adhesives described in U.S. Pat. No. 5,824,748, which is incorporated herein by reference in its entirety. In addition, or alternatively, in some embodiments, the front side 104 of the tab 102 (or the front side of an adjacent sheet in the stack 152) can include a release coating in order to achieve minimal, or lack of, affinity between the adhesive and the surface. That is, in some embodiments, the front side 104 of the tab 102 (or the front side of an adjacent sheet in the stack 152) can function as a release (or releasable) liner for the adhesive. In addition, or alternatively, the front side 104 of the tab 102 (or the front side of adjacent sheet in the stack 152) can be glazed to enhance slidability, e.g., with itself. Examples of release coatings or low adhesion backsize (LAB) materials that can be applied to the front surface 104 of the tab 102 (or to the front side of the sheets in the stack 152) can be found in U.S. Pat. Nos. 5,744,207, 5,874,144, 6,352,766, and 6,420,480, which are incorporated herein by reference in their entirety. For example, adhesive POST-IT® note products (e.g., the sheet or paper, as well as the adhesives) available under the trade designation “SUPER STICKY” (3M Company, St. Paul, Minn.), can be employed as the sheets in the stack 152.

As shown in FIG. 1, in some embodiments of the present disclosure, a plurality of tabs 102 can be provided in a sheet assembly 50 separated from an adjacent tab 102 by at least one of a fold and a perforation 54. Two rows of three tabs 102 (for a total of six tabs 102) are shown in the sheet assembly 50 by way of example only; however it should be understood that the sheet assembly 50 can be sized to accommodate as few as one tab 102 and as many as desired.

As shown in the embodiment illustrated in FIG. 1, the sheet assembly 50 can include a side-to-side configuration, such that at least one side of the tab 102 (e.g., at least one side of the tab portion 132 and/or the body portion 130 of each of the plurality of tabs 102) can be separated from a side of an adjacent tab 102 by a fold and/or perforation 54.

In addition, or alternatively, as shown in FIG. 1, the sheet assembly 50 can include an end-to-end configuration, such that at least one end (e.g., the first end 116 and/or the bottom end 118) of the tab 102 can be separated from an end (e.g., a first end 116 or a second end 116, not necessarily respectively) of an adjacent tab 102 by a fold and/or perforation 54.

In some embodiments, the sheet assembly 50 can be folded at each fold or perforation 54, either in the same direction as the previous fold 54 to essentially form a roll, or in alternating fashion (e.g., in a zig-zag fashion) to form a stack. In such a stack, the tabs 102 can be arranged such that the front side 104 of each tab 102 is positioned to face the front side 104 of an adjacent tab 102, or such that the front side 104 of each tab 102 is positioned to face the back side 106 of an adjacent tab 102, or a combination thereof.

In some embodiments, the sheet assembly 50 can be rolled along its length (e.g., from left to right in FIG. 1), and can be provided in a rolled configuration. Such a roll can be accessed from a dispenser, and as many tabs 102 as desired can be removed at a given time by separating the sheet assembly 50 along one or more perforations 54.

In FIG. 1, by way of example only, the plurality of tabs 102 are illustrated as being connected to, at most, two or three other tabs 102 in a double strip; however, it should be understood that the tabs 102 can instead be provided in large sheet assemblies 50 of tabs 102 in which each tab 102 is connected on all sides to another tab 102. Alternatively, the tabs 102 (e.g., separated from at least one adjacent tab 102 by the perforation and/or fold 54) can be provided in a roll, or rolled configuration.

The sheet assembly 50 is shown as including a plurality of the tabs 102 of FIGS. 1-4; however, it should be understood that other configurations of the tab of the present disclosure can instead be provided in the sheet assembly 50, and in some embodiments, a variety of tabs can be employed in one sheet assembly 50. However, in some embodiments, manufacturing of the sheet assembly 50 can be facilitated by having all of the tabs formed therein being the same type of tab.

Similarly, as shown in FIG. 2, in some embodiments of the present disclosure, a plurality of binder clip tabs 100 can be provided in a sheet assembly 50′ separated from an adjacent binder clip tab 100 by at least one of a fold and a perforation 54′. Two rows of three binder clip tabs 100 (for a total of six binder clip tabs 100) are shown in the sheet assembly 50′ by way of example only; however it should be understood that the sheet assembly 50′ can be sized to accommodate as few as one binder clip tab 100 and as many as desired.

As shown in the embodiment illustrated in FIG. 2, the sheet assembly 50′ can include a side-to-side configuration, such that at least one side of the binder clip tab 100 (e.g., at least one side of the tab portion 132 and/or the body portion 130 of each of the plurality of binder clip tabs 100) can be separated from a side of an adjacent binder clip tab 100 by a fold and/or perforation 54′.

In addition, or alternatively, as shown in FIG. 2, the sheet assembly 50′ can include an end-to-end configuration, such that at least one end (e.g., the first end 116 and/or the bottom end 118) of the binder clip tab 100 can be separated from an end (e.g., a first end 116 or a second end 116, not necessarily respectively) of an adjacent binder clip tab 100 by a fold and/or perforation 54′.

In some embodiments, the sheet assembly 50′ can be folded at each fold or perforation 54′, either in the same direction as the previous fold 54′ to essentially form a roll, or in alternating fashion (e.g., in a zig-zag fashion) to form a stack. In such a stack, the binder clip tabs 100 can be arranged such that the front side 104 of each tab 102 is positioned to face the front side 104 of an adjacent tab 102, or such that the front side 104 of each tab 102 is positioned to face the back side 106 of an adjacent tab 102, or a combination thereof.

In some embodiments, the sheet assembly 50′ can be rolled along its length (e.g., from left to right in FIG. 2), and can be provided in a rolled configuration. Such a roll can be accessed from a dispenser, and as many binder clip tabs 100 as desired can be removed at a given time by separating the sheet assembly 50′ along one or more perforations 54′.

In FIG. 2, by way of example only, the plurality of binder clip tabs 100 are illustrated as being connected to, at most, two or three other binder clip tabs 100 in a double strip; however, it should be understood that the binder clip tabs 100 can instead be provided in large sheet assemblies 50′ of binder clip tabs 100 in which each binder clip tab 100 is connected on all sides to another binder clip tab 100. Alternatively, the binder clip tabs 100 (e.g., separated from at least one adjacent binder clip tab 100 by the perforation and/or fold 54′) can be provided in a roll, or rolled configuration.

In some embodiments, the binder clips 105 of one binder clip tab 100 can be clipped or bound to at least a portion of an adjacent binder clip tab 100 (e.g., to the tab 102 of an adjacent binder clip tab 100). For example, in some embodiments, the first row of FIG. 2 can include binder clip tabs 100 separated from one another by the fold and/or perforation 54′, and the first row of binder clips 105 can be clipped to a second row of binder clip tabs 100 that are separated from each other (i.e., within the second row) by the fold and/or perforation 54′.

The sheet assembly 50′ is shown as including a plurality of the binder clip tabs 100 of FIGS. 1-4; however, it should be understood that other configurations of the tab of the present disclosure can instead be provided in the sheet assembly 50′, and in some embodiments, a variety of tabs can be employed in one sheet assembly 50′. However, in some embodiments, manufacturing of the sheet assembly 50′ can be facilitated by having all of the binder clip tabs formed therein being the same type of binder clip tab.

The tab 102 of FIGS. 1-4 is illustrated as one exemplary embodiment of the tab of the present disclosure; however, it should be understood that a combination of any of the embodiments illustrated in the figures and described herein can be employed in the tabs or binder clip tabs of the present disclosure.

In some embodiments, the tabs 102 of the present disclosure can be provided with one or more binder clips 105 in a kit, where the binder clip 105 can be reused with each of the tabs 102 provided in the kit. For example, in some embodiments, a first tab 102 can be coupled to the binder clip 105 of the kit to provide a binder clip tab 100. When the first tab 102 is ready for replacement (e.g., the tab 102 is beginning to show signs of wear, or the stack 152 (if employed) has been used up), the binder clip 105 can be removed from the first tab 102 via the aperture 112 and the one or more movable members 114, and a second tab 102 can be placed onto the binder clip 105, and so on. In some embodiments, the tabs 102 can be provided in a sheet assembly 50. In some embodiments, the first tab 102 and the second tab 102 can be the same type of tab, and in some embodiments, the first tab 102 and the second tab 102 can be different.

FIG. 5 shows a front view of a tab 202 according to another embodiment of the present disclosure. The aperture 212 of the tab 202 is not symmetrical about the longitudinal axis A′. In addition, while the first portion 236 of the aperture 212 is oriented perpendicularly with respect to the second portion 238 of the aperture 212, the second portion 238 is not centered with respect to the first portion 236 of the aperture 212. As such, the movable members 214 formed or defined at least partially by the aperture 212 are not symmetrically positioned about the longitudinal axis A′, nor are their living hinges 215. In addition, the living hinges 215 are oriented substantially perpendicularly with respect to one another. As shown, the first portion 236 and the second portion 238 can at least partially form or define two movable members 214; however, in some embodiments, one or more of the illustrated movable members 214 can be large enough and/or rigid enough that the tab 202 essentially only includes one movable member 214. The same can be said for the movable members 114 of the tab 102 of FIGS. 1-4. For example, in some embodiments, the portion of the tab 202 that forms the movable member(s) 214 can be formed of a thinner and/or more flexible material, such that the flex of the movable member(s) 214 can be controlled, and such that the location and number of the movable member(s) 214 can be controlled.

Furthermore, as shown, the tab 202 is another example of where the first portion 236 of the aperture 212 is oriented substantially parallel with an end (e.g., a bottom end 218) of the tab 202, and the second portion 238 is oriented substantially perpendicularly with respect to that same end. Also, the second portion 238 that connects the first portion 236 to the side edge 210 of the tab 202 is positioned to extend through (and connect the first portion 236 of the aperture 212 to) the bottom end 218 of the tab 202.

FIG. 6 shows a front view of a tab 302 according to another embodiment of the present disclosure. The aperture 312 of the tab 302 is not symmetrical about the longitudinal axis A″. In addition, the first portion 336 of the aperture 312 is oriented substantially parallel with respect to the second portion 338 of the aperture 312. Furthermore, the second portion 338 is not centered with respect to the first portion 336 of the aperture 312, but rather serves as a narrower side extension of the first portion 336 of the aperture 312 to connect the first portion 336 to the side edge 310 of the tab 302. The movable members 314 formed or defined at least partially by the aperture 312 are not symmetrically positioned about the longitudinal axis A″, nor are their living hinges 315. In addition, the living hinges 315 are oriented substantially perpendicularly with respect to one another. As shown, the first portion 336 and the second portion 338 can at least partially form or define two movable members 314; however, in some embodiments, one or more of the illustrated movable members 314 can be large enough and/or rigid enough that the tab 302 essentially only includes one movable member 314. For example, in some embodiments, the portion of the tab 302 that forms the movable member(s) 314 can be formed of a thinner and/or more flexible material, such that the flex of the movable member(s) 314 can be controlled, and such that the location and number of the movable member(s) 314 can be controlled.

Furthermore, as shown, the tab 302 is another example of where the first portion 336 of the aperture 312 is oriented substantially parallel with an end (e.g., a bottom end 318) of the tab 302, and the second portion 338 is also oriented substantially parallel with respect to that same end. Also, the second portion 338 that connects the first portion 336 to the side edge 310 of the tab 302 is positioned to extend through (and connect the first portion 336 of the aperture 312 to) a side (e.g., the right side 319) of the tab 302.

While the tabs 102, 202, 302 shown in the figures and described herein are illustrated as separate embodiments employing various features and elements, it should be understood that the binder clip tabs of the present disclosure can employ any combination of features and elements described herein. For example, the binder clip tab 100 can employ any of the tabs 102, 202, 302 described herein and illustrated in the figures, or any tabs that fall within the spirit and scope of the present disclosure that may not be explicitly illustrated in the figures.

In the embodiments illustrated in the figures and described herein, the terms “first portion,” “second portion,” “first leg,” “second leg,” and the like, are used for clarity and illustration only. However, it should be understood that the “first portion” of the sheet can instead be the “second portion,” etc., and that these terms are in no way intended to be limiting. For example, in some embodiments, the first leg 122 of the binder clip tab 100 can instead be referred to as the “second leg” 122, etc.

The following embodiments are intended to be illustrative of the present disclosure and not limiting.

### EMBODIMENTS

1. A binder clip tab for coupling to an object having an edge, the binder clip tab comprising:

a binder clip having a binding portion comprising a first leg and a second leg that are biased toward one another and configured to retain at least a portion of the object between the first leg and the second leg; and

a tab having a front side, a back side, and a side edge, and being configured to be removably coupled to the binding portion of the binder clip, the tab including an aperture dimensioned to receive at least a portion of the binding portion of the binder clip therethrough, the aperture extending through the side edge of the tab to form at least one movable member in the tab,

at least a portion of the tab positioned to extend beyond a top end of the binding portion of the binder clip, such that when the binder clip tab is coupled to the object, the tab extends beyond the edge of the object.

2. The binder clip tab of embodiment 1, wherein the tab is wider than the binder clip.

3. The binder clip tab of embodiment 1 or 2, wherein the tab is a first tab, and further comprising a second tab, wherein the first tab and the second tab are each configured to be removably coupled to the binder clip.

4. The binder clip tab of any of embodiments 1-3, wherein the binder clip further includes a first leverage arm and a second leverage arm, wherein each leverage arm is movable between a first position in which the leverage arm is positioned to be pressed toward the other leverage arm to move the first leg and the second leg apart against their bias and a second position in which the leverage arms does not provide leverage against the bias between the first leg and the second leg.

5. The binder clip tab of any of embodiments 1-4, wherein the binder clip tab is one of a plurality of binder clip tabs provided in a sheet assembly, each of the plurality of binder clip tabs separated from an adjacent binder clip tab by at least one of a fold and a perforation.

6. The binder clip tab of embodiment 5, wherein at least one side of each of the plurality of binder clip tabs is separated from a side of an adjacent binder clip tab by the at least one of a fold and a perforation.

7. The binder clip tab of embodiment 5 or 6, wherein at least one of a first end and a second end of each of the plurality of binder clip tabs is separated from a first end or a second end of an adjacent binder clip tab by the at least one of a fold and a perforation.

8. The binder clip tab of any of embodiments 5-7, wherein the binder clip of at least one of the plurality of binder clip tabs is clipped to an adjacent binder clip tab.

9. A tab for removably coupling to a binder clip having a binding portion, the tab comprising:

a front side;

a back side opposite the front side;

a side edge; and

an aperture dimensioned to receive at least a portion of the binding portion of the binder clip, the aperture extending through the side edge of the tab to form at least one movable member in the tab,

at least a portion of the tab positioned to extend beyond a top end of the binding portion of the binder clip when the tab and the binder clip are coupled together.

10. The tab of embodiment 9 or the binder clip tab of any of embodiments 1-8, wherein the at least one movable member is movable between a first position in which the at least one movable member is co-planar with the tab and a second position in which the at least one movable member is not co-planar with the tab.

11. The tab of embodiment 9 or 10 or the binder clip tab of any of embodiments 1-8 and 10, further comprising a multi-layer stack of adhesive-backed sheets of film or paper coupled to at least one of the front side and the back side of the tab.

12. The binder clip tab of embodiment 11, wherein at least a portion of the multi-layer stack extends beyond the edge of the object.

13. The tab or binder clip tab of embodiment 11, wherein the multilayer stack is replaceable.

14. The tab of any of embodiments 9-11 and 13 or the binder clip tab of any of embodiments 1-8 and 10-13, wherein the side edge of the tab is formed at least by a top end and a bottom end, and wherein the aperture extends through at least one of the top end and the bottom end of the tab.

15. The tab of any of embodiments 9-11 and 13-14 or the binder clip tab of any of embodiments 1-8 and 10-14, wherein the side edge of the tab is formed at least by a first side, and a second side, and wherein the aperture extends through at least one of the first side and the second side of the tab.

16. The tab of any of embodiments 9-11 and 13-15 or the binder clip tab of any of embodiments 1-8 and 10-15, wherein the aperture is symmetrical with respect to a longitudinal axis of the tab.

17. The tab of any of embodiments 9-11 and 13-16 or the binder clip tab of any of embodiments 1-8 and 10-16, wherein the aperture includes

a first portion configured to retain at least a portion of the binding portion of the binder clip, and

a second portion configured to connect the first portion of the aperture to the side edge of the tab, such that the second portion of the aperture extends through the side edge.

18. The tab or binder clip tab of embodiment 17, wherein the first portion and the second portion of the aperture are oriented substantially perpendicularly with respect to one another.

19. The tab or binder clip tab of embodiment 17, wherein the first portion and the second portion of the aperture are arranged in a substantially parallel orientation with respect to one another.

20. The tab or binder clip tab of any of embodiments 17-19, wherein the second portion of the aperture extends through a side of the tab.

21. The tab or binder clip tab of any of embodiments 17-20, wherein the second portion of the aperture extends through a bottom end of the tab.

22. The binder clip tab of any of embodiments 1-8 and 10-21, wherein the at least one movable member formed in the tab is positioned at least partially between the first leg and the second leg of the binder clip when the tab is coupled to the binder clip.

23. The tab of any of embodiments 9-11 and 13-22 or the binder clip tab of any of embodiments 1-8 and 10-22, wherein the at least one movable member is movable with respect to a remainder of the tab about a living hinge.

24. The tab of any of embodiments 9-11 and 13-23 or the binder clip tab of any of embodiments 1-8 and 10-23, wherein at least one of the front side and the back side of the tab is at least one of writable, printable, and stainable.

25. The tab of any of embodiments 9-11 and 13-24 or the binder clip tab of any of embodiments 1-8 and 10-24, wherein the tab is one of a plurality of tabs provided in a sheet assembly, each of the plurality of tabs separated from an adjacent tab by at least one of a fold and a perforation.

26. The tab or binder clip tab of embodiment 25, wherein at least one side of each of the plurality of tabs is separated from an adjacent tab by the at least one of a fold and a perforation.

27. The tab or binder clip tab of embodiment 25 or 26, wherein at least one of a first end and a second end of each of the plurality of tabs is separated from an adjacent tab by the at least one of a fold and a perforation.

The embodiments described above and illustrated in the figures are presented by way of example only and are not intended as a limitation upon the concepts and principles of the present disclosure. As such, it will be appreciated by one having ordinary skill in the art that various changes in the elements and their configuration and arrangement are possible without departing from the spirit and scope of the present disclosure.

All references and publications cited herein are expressly incorporated herein by reference in their entirety into this disclosure.

Various features and aspects of the present disclosure are set forth in the following claims.

1. A binder clip tab for coupling to an object having an edge, the binder clip tab comprising:
a binder clip having a binding portion comprising a first leg and a second leg that are biased toward one another and configured to retain at least a portion of the object between the first leg and the second leg; and
a tab having a front side, a back side, and a side edge, and being configured to be removably coupled to the binding portion of the binder clip, the tab including an aperture dimensioned to receive at least a portion of the binding portion of the binder clip therethrough, the aperture extending through the side edge of the tab to form at least one movable member in the tab,
at least a portion of the tab positioned to extend beyond a top end of the binding portion of the binder clip, such that when the binder clip tab is coupled to the object, the tab extends beyond the edge of the object.

2. The binder clip tab of claim 1, wherein the tab is wider than the binder clip.

3. The binder clip tab of claim 1, wherein the tab is a first tab, and further comprising a second tab, wherein the first tab and the second tab are each configured to be removably coupled to the binder clip.

4. The binder clip tab of claim 1, wherein the binder clip further includes a first leverage arm and a second leverage arm, wherein each leverage arm is movable between a first position in which the leverage arm is positioned to be pressed toward the other leverage arm to move the first leg and the second leg apart against their bias and a second position in which the leverage arms does not provide leverage against the bias between the first leg and the second leg.

5. The binder clip tab of claim 1, wherein the binder clip tab is one of a plurality of binder clip tabs provided in a sheet assembly, each of the plurality of binder clip tabs separated from an adjacent binder clip tab by at least one of a fold and a perforation.

6. The binder clip tab of claim 5, wherein at least one side of each of the plurality of binder clip tabs is separated from a side of an adjacent binder clip tab by the at least one of a fold and a perforation.

7. A tab for removably coupling to a binder clip having a binding portion, the tab comprising:
a front side;
a back side opposite the front side;
a side edge; and
an aperture dimensioned to receive at least a portion of the binding portion of the binder clip, the aperture extending through the side edge of the tab to form at least one movable member in the tab,
at least a portion of the tab positioned to extend beyond a top end of the binding portion of the binder clip when the tab and the binder clip are coupled together.

8. The tab of claim 7, wherein the at least one movable member is movable between a first position in which the at least one movable member is co-planar with the tab and a second position in which the at least one movable member is not co-planar with the tab.

9. The tab of claim 7, further comprising a multi-layer stack of adhesive-backed sheets of film or paper coupled to at least one of the front side and the back side of the tab.

10. The tab of claim 7, wherein the side edge of the tab is formed at least by a top end and a bottom end, and wherein the aperture extends through at least one of the top end and the bottom end of the tab.

11. The tab of claim 7, wherein the side edge of the tab is formed at least by a first side, and a second side, and wherein the aperture extends through at least one of the first side and the second side of the tab.

12. The tab of claim 7, wherein the aperture is symmetrical with respect to a longitudinal axis of the tab.

13. The tab of claim 7, wherein the aperture includes
a first portion configured to retain at least a portion of the binding portion of the binder clip, and
a second portion configured to connect the first portion of the aperture to the side edge of the tab, such that the second portion of the aperture extends through the side edge.

14. The tab of claim 13, wherein the first portion and the second portion of the aperture are oriented substantially perpendicularly with respect to one another.

15. The tab of claim 13, wherein the first portion and the second portion of the aperture are arranged in a substantially parallel orientation with respect to one another.

16. The tab of claim 13, wherein the second portion of the aperture extends through a side of the tab.

17. The tab of claim 13, wherein the second portion of the aperture extends through a bottom end of the tab.

18. The binder clip tab of claim 1, wherein the at least one movable member formed in the tab is positioned at least partially between the first leg and the second leg of the binder clip when the tab is coupled to the binder clip.

19. The tab of claim 7, wherein the at least one movable member is movable with respect to a remainder of the tab about a living hinge.

20. The tab of claim 7, wherein at least one of the front side and the back side of the tab is at least one of writable, printable, and stainable.

21. The tab of claim 7, wherein the tab is one of a plurality of tabs provided in a sheet assembly, each of the plurality of tabs separated from an adjacent tab by at least one of a fold and a perforation.
